(19) United States
(12) Patent Application Publication
(10) Pub. No.: US 2025/0269420 A1
(43) Pub. Date: Aug. 28, 2025

(54) DIAGNOSTIC AND MONITORING SYSTEM FOR A DIE NECKING MACHINE

(71) Applicant: Stolle Machinery Company, LLC, Centennial, CO (US)

(72) Inventor: Karthik Ramakrishnan, Aurora, CO (US)

(73) Assignee: Stolle Machinery Company, LLC, Centennial, CO (US)

(21) Appl. No.: 18/586,668

(22) Filed: Feb. 26, 2024

(51) Int. Cl. B21D 51/26; B21C 51/00

(52) U.S. Cl. CPC B21D 51/2638; B21C 51/00

(57) ABSTRACT

A processing station for a die necking machine includes a frame, a forming cam arrangement fixedly coupled to the frame, a knockout cam arrangement fixedly coupled to the frame, and a process turret rotatably coupled to the frame. The process turret includes a forming cam follower operatively coupled to the forming cam arrangement and a knockout cam follower operatively coupled to the knockout cam arrangement. One or both of the forming cam arrangement and/or the knockout cam arrangement includes a cam body having a cam surface defining a cam profile, the cam surface configured to be engaged by a cam follower of one of the forming cam follower or the knockout cam follower. The processing station further includes a sensing arrangement for determining a force applied to a portion of the cam surface by the cam follower of the one of the forming cam follower or the knockout cam follower.

### FIELD OF THE INVENTION

The disclosed concept relates generally to die necking machines for forming portions of can bodies and, more particularly, to die necking machines having one or more cam arrangements which can sense forces to which they are being subjected by mechanisms driven thereby in the die necking machines. The disclosed concept further relates to methods for monitoring die necking machines during operation for conditions requiring service.

### BACKGROUND OF THE INVENTION

Can bodies are, typically, formed in a bodymaker. That is, a bodymaker forms blanks such as, but not limited to, disks or cups into an elongated can body. A can body includes a base and a depending sidewall. The sidewall is open at the end opposite the base. The bodymaker, typically, includes a ram/punch that moves the blanks through a number of dies to form the can body. The can body is ejected from the ram/punch for further processing such as, but not limited to, trimming, washing, printing, flanging, and inspecting before being placed on pallets which are shipped to the filler. At the filler, the cans are taken off of the pallets, filled, ends installed on them and then the filled cans are repackaged in six packs and/or twelve pack cases, etc.

Some can bodies are further formed in a die necking machine, commonly referred to as a “necker machine”, or simply a “necker”. Necker machines are structured to reduce the cross-sectional area of a portion of a can body sidewall, i.e., at the open end of the sidewall. That is, prior to coupling a can end to the can body, the diameter/radius of the can body sidewall open end is reduced relative to the diameter/radius of other portions of the can body sidewall. The necker machine includes a number of processing and/or forming stations disposed in series. That is, the processing and/or forming stations are disposed adjacent to each other and a transfer assembly moves a can body between adjacent processing and/or forming stations. As the can body moves through the processing and/or forming stations it is processed or formed.

Conventional necker machine arrangements provide for little to no diagnostic information for preventing forming jams. When such forming jams occur, the necker machine must be stopped in order to clear the jam, assess potential damage to the forming die(s) or other parts involved, and make any adjustments/repairs needed to the machine. Such jams thus reduce productivity of the machine and create spoilage, both of which are undesirable.

### SUMMARY OF THE INVENTION

Embodiments of the disclosed concept provide for diagnostic and monitoring information of a die necker machine during normal necking operations of the machine. By providing such information, embodiments of the disclosed concept reduce/prevent neck forming jams which in turn increases the productivity of the machine and reduces spoilage. Embodiments of the disclosed concept also help to define the exact force(s) needed to form a neck on a can at various stages of the necking process, information that can be employed to optimize the neck forming operation and thus reduce the overall time and energy required to carried out such operation.

As one aspect of the disclosed concept a processing station for use in a die necking machine is provided. The processing station comprises: a frame; a forming cam arrangement fixedly coupled to the frame; a knockout cam arrangement fixedly coupled to the frame; and a process turret rotatably coupled to the frame, the process turret comprising: a forming cam follower operatively coupled to the forming cam arrangement; and a knockout cam follower operatively coupled to the knockout cam arrangement, wherein one or both of the forming cam arrangement and/or the knockout cam arrangement comprises: a cam body having a cam surface defining a cam profile, the cam surface configured to be engaged by a cam follower of one of the forming cam follower or the knockout cam follower; and a sensing arrangement structured to determine a force applied to a portion of the cam surface by the cam follower of the one of the forming cam follower or the knockout cam follower.

The portion of the cam surface may bound a portion of the cam body that is sized and configured to deform in a predetermined manner responsive to one or more forces applied to the portion of the cam surface via the one of the cam follower; and the sensing arrangement may be structured to monitor deformation of the portion of the cam body. The cam body may comprise a pocket defined therein, and the portion of the cam body may be disposed between the pocket and the portion of the cam surface. The sensing arrangement may comprise a sensor disposed at least partially within the pocket. The sensor may comprise a strain gauge coupled to the portion of the cam body or a pressure sensor engaged with the portion of the cam body. The sensing arrangement may comprise a controller in communication with the sensor. The controller may be structured to determine the force exerted by the cam follower from the deformation.

Each of the forming cam arrangement and the knockout cam arrangement may comprise: the cam body having the cam surface defining the cam profile; and the sensing arrangement structured to determine the force applied to the portion of the cam surface.

The sensing arrangement may be structured to determine forces applied to a plurality of portions of the cam surface by the cam follower of the one of the forming cam follower or the knockout cam follower.

As another aspect of the disclosed concept, a die necking machine for use in forming can bodies is provided. The die necking machine comprises a plurality of processing stations as described above.

As yet a further aspect of the disclosed concept, a method for determining a condition requiring service in a processing station of a die necking machine such as described above is provided. The method comprises: monitoring force applied to at least a portion of the cam surface by the cam follower of the one of the forming cam follower or the knockout cam follower during operation of the die necking machine; determining that the force applied to the portion of the cam surface has varied more than a predetermined amount from a predetermined value; and performing an action responsive to determining that the force has varied more than the predetermined amount.

Performing the action may comprise stopping operation of the die necking machine.

These and other objects, features, and characteristics of the disclosed concept, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed concept.

### BRIEF DESCRIPTION OF THE DRAWINGS

A full understanding of the disclosed concept can be gained from the following description of the preferred embodiments when read in conjunction with the accompanying drawings in which:

FIG. 1 is a perspective view of a necker machine in accordance with an example embodiment of the disclosed concept;

FIG. 2 is another perspective view of the necker machine of FIG. 1;

FIG. 3 is a front elevation view of the necker machine of FIGS. 1 and 2;

FIG. 4 is a schematic cross-sectional view of a can body;

FIG. 5 is a perspective view of a processing station of the necker machine of FIGS. 1-3 shown with selected components removed to show details of components relevant to the disclosed concept;

FIG. 6 is a side elevation view of a processing station of FIG. 5 shown with the process turret and components thereof rotated a quarter of a rotation in an operating direction;

FIG. 7A is a partially schematic detail view of the portion of FIG. 6 indicated in FIG. 6; and

FIG. 7B is a partially schematic detail view of the portion of FIG. 6 indicated in FIG. 6.

### DETAILED DESCRIPTION OF THE INVENTION

The specific elements illustrated in the drawings and described herein are simply exemplary embodiments of the disclosed concept. Accordingly, specific dimensions, orientations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. As used herein, “adjustably fixed” means that two components are coupled so as to move as one while maintaining a constant general orientation or position relative to each other while being able to move in a limited range or about a single axis. For example, a doorknob is “adjustably fixed” to a door in that the doorknob is rotatable, but generally the doorknob remains in a single position relative to the door. Further, a cartridge (nib and ink reservoir) in a retractable pen is “adjustably fixed” relative to the housing in that the cartridge moves between a retracted and extended position, but generally maintains its orientation relative to the housing. Accordingly, when two elements are coupled, all portions of those elements are coupled. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.”

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “temporarily coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, the term “number” shall mean one or an integer greater than one (i.e., a plurality). That is, for example, the phrase “a number of elements” means one element or a plurality of elements. It is specifically noted that the term “a ‘number’ of [X]” includes a single [X].

As employed herein, the terms “can” and “container” are used substantially interchangeably to refer to any known or suitable container, which is structured to contain a substance (e.g., without limitation, liquid, food, any other suitable substance), and expressly includes, but is not limited to, beverage cans, such as beer and soda cans, as well as food cans.

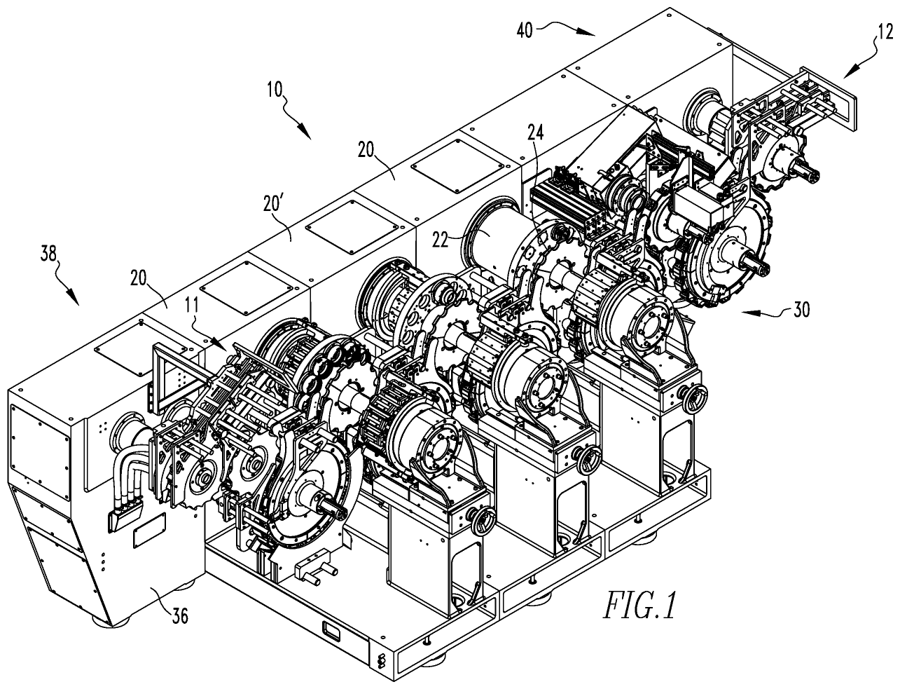

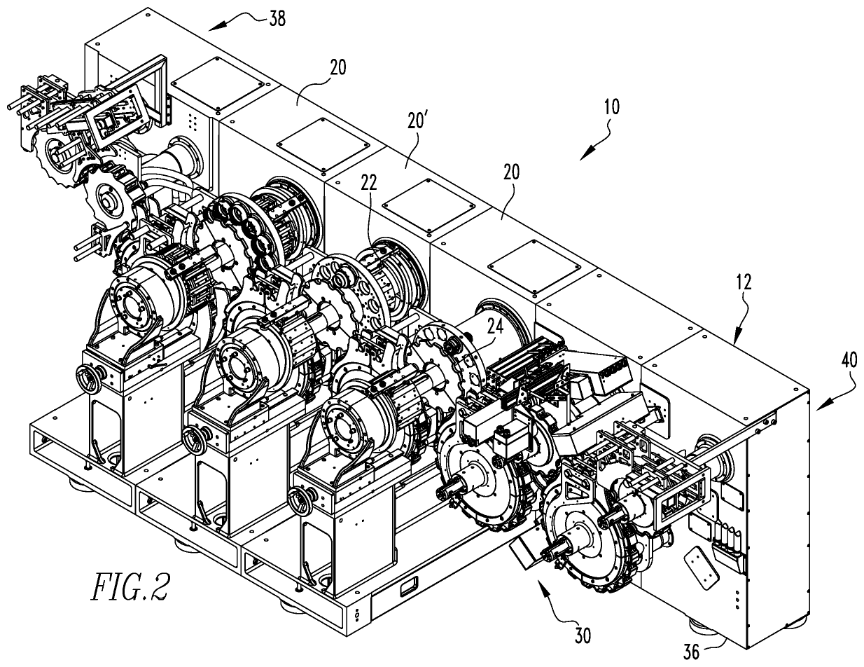

As shown in FIGS. 1-3, a necker machine 10 is structured to reduce the diameter of a portion of a can body 1. Necker machine 10 is of similar construction and operates in a similar manner as necker machines described in U.S. Pat. Nos. 11,370,015 and 11,565,303 commonly assigned to the same assignee as the present application except for the cam arrangements 70 and 80 described herein and components related thereto. Accordingly, only a general overview of major components of necker machine 10 and the general operation thereof is provided herein.

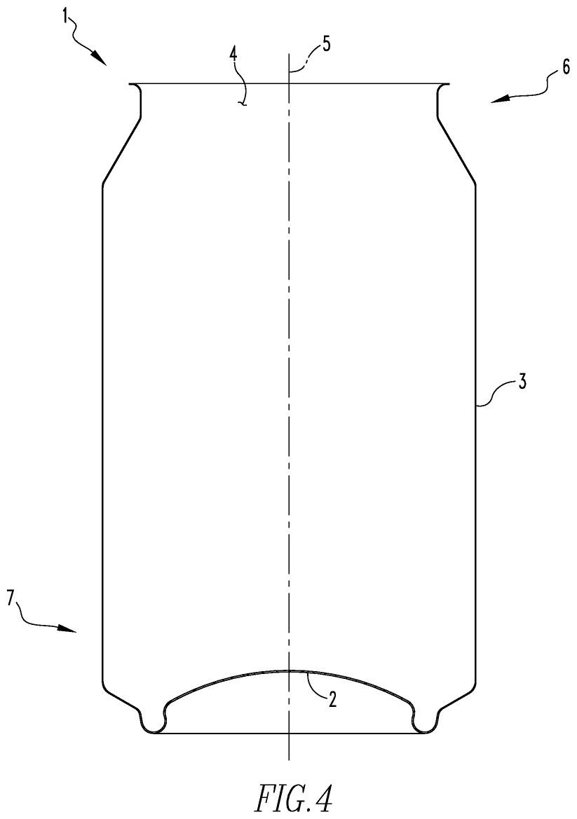

As used herein, to “neck” means to reduce the diameter/radius of a portion of a can body 1. That is a can body 1, such as shown (for example, without limitation) in FIG. 4, includes a base 2 with an upwardly depending sidewall 3. The base 2 and sidewall 3 define a generally enclosed space 4. In the embodiment discussed below, the can body 1 is a generally circular and/or an elongated cylinder. It is understood that this is only one exemplary shape and that the can body 1 can have other shapes. The can body 1 has a longitudinal axis 5. The sidewall 3 has a first end 6 and a second end 7. The base 2 is at the second end 7 and the first end 6 is open. The first end 6 initially has substantially the same radius/diameter as the sidewall 3, however following forming operations in the necker machine 10, the radius/diameter of the first end 6 is smaller than the other portions of the radius/diameter at the sidewall 3.

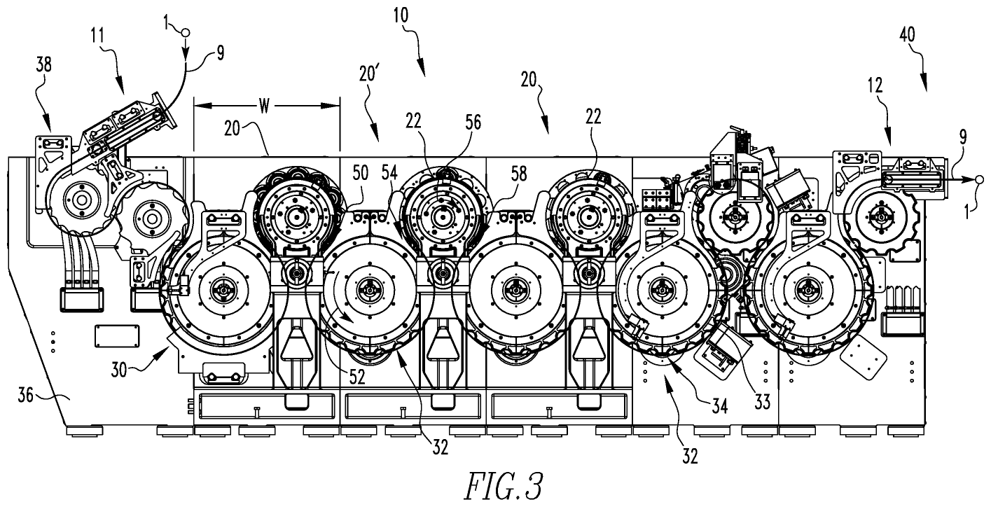

The necker machine 10 includes an infeed assembly 11, a plurality of processing/forming stations 20, a transfer assembly 30, and a drive assembly (not numbered). Hereinafter, processing/forming stations 20 are identified by the term “processing stations 20” and refer to generic processing stations 20. As is known, the processing stations 20 are disposed adjacent to each other and in series. That is, the can bodies 1 being processed by the necker machine 10 each move from an upstream location through a series of processing stations 20 in the same sequence. The can bodies 1 follow a path, hereinafter, the “work path 9” (FIG. 3). That is, the necker machine 10 defines the work path 9 wherein can bodies 1 move from an “upstream” location to a “downstream” location; as used herein, “upstream” generally means closer to the infeed assembly 11 and “downstream” means closer to an exit assembly 12. With regard to elements that define the work path 9, each of those elements have an “upstream” end and a “downstream end” wherein the can bodies move from the “upstream” end to the “downstream end.” Thus, as used herein, the nature/identification of an element, assembly, sub-assembly, etc. as an “upstream” or “downstream” element or assembly, or, being in an “upstream” or “downstream” location, is inherent. Further, as used herein, the nature/identification of an element, assembly, sub-assembly, etc. as an “upstream” or “downstream” element or assembly, or, being in an “upstream” or “downstream” location, is a relative term.

Each processing station 20 has a similar width W (FIG. 3) and the can body 1 is processed and/or formed (or partially formed), i.e., “necked”, as the can body 1 moves across the width. Generally, the processing/forming occurs in/at a process turret 22. That is, the term “process turret 22” identifies a generic turret. Each processing station 20 includes a non-vacuum starwheel 24. As used herein, a “non-vacuum starwheel” means a starwheel that does not include, or is not associated with, a vacuum assembly that is structured to apply a vacuum to the starwheel pockets. Further, each processing station 20 typically includes one process turret 22 and one non-vacuum starwheel 24.

The transfer assembly 30 is structured to move the can bodies 1 between adjacent processing stations 20. The transfer assembly 30 includes a plurality of vacuum starwheels 32. As used herein, a “vacuum starwheel” means a starwheel assembly that includes, or is associated with, a vacuum assembly that is structured to apply a vacuum to the starwheel pockets 34. Further, the term “vacuum starwheel 32” identifies a generic vacuum starwheel 32. A vacuum starwheel 32 includes disk-like body (FIG. 3) or disk-like body assembly, and a plurality of pockets 34 disposed on the radial surface of the disk-like body 33. When used in association with generally cylindrical can bodies 1, the pockets 34 are generally semi-cylindrical. A vacuum assembly (not numbered), selectively applies suction to the pockets 34 and is structured to selectively couple a can body 1 to a pocket 34. It is understood, and as used herein, that “to apply a vacuum to a pocket 34” means that a vacuum (or suction) is applied to a starwheel pocket via at least one suitable passage. As such, components of the transfer assembly 30 such as, but not limited to, the vacuum starwheels 32 are also identified as parts of the processing stations 20. Conversely, the non-vacuum starwheel 24 of the processing stations 20 also move the can bodies 1 between processing stations 20 so the non-vacuum starwheels 24 are also identified as part of the transfer assembly 30.

It is noted that the plurality of processing stations 20 are structured to neck different types of can bodies 1 and/or to neck can bodies in different configurations. Thus, each processing station 20 of the plurality of processing stations 20 is structured to be added and removed from the necker machine 10 depending upon the need. To accomplish this, the necker machine 10 includes a frame assembly 36 to which the plurality of processing stations 20 are removably coupled. Alternatively, the frame assembly 36 includes elements incorporated into each of the plurality of processing station 20 so that the plurality of processing stations 20 are structured to be temporarily coupled to each other. The frame assembly 36 has an upstream end 38 and a downstream end 40. Further, the frame assembly 36 includes elongated members, panel members (neither numbered), or a combination of both. As is known, panel members coupled to each other, or coupled to elongated members, form a housing. Accordingly, as used herein, a housing is also identified as a “frame assembly 36.”

Generally, each processing station 20 is structured to partially form (i.e., neck) the can body 1 so as to reduce the cross-sectional area of the can body first end 6 a predetermined amount. The processing stations 20 include some elements that are unique to a single processing station 20, such as, but not limited to, a specific die. Other elements of the processing stations 20 are common to all, or most, of the processing stations 20. The following discussion is related to the common elements and, as such, the discussion is directed to a single generic processing (forming) station 20′ of the processing stations 20. It is understood, however, that any processing station 20 can include the elements discussed below.

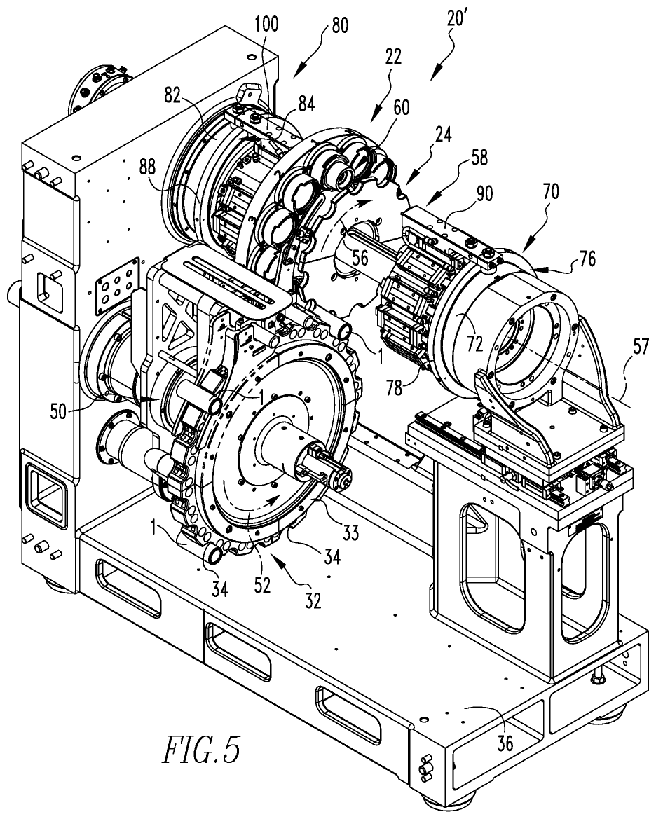

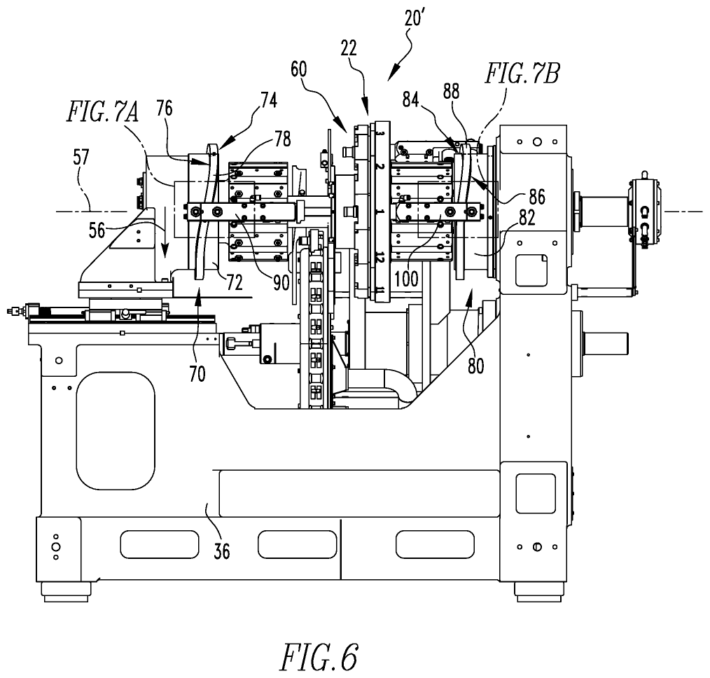

Referring generally now to the isolated view of the representative processing station 20′ of FIGS. 5 and 6, during necking operations carried out by the necker machine 10, a can body 1 is received in one of the pockets 34 of the vacuum starwheel 32 of the processing station 20′ generally at a receiving point, such as generally indicated at 50. Depending on the positioning of the processing station 20′, the can body 1 received at 50 may be received from an infeed assembly 11 or from a non-vacuum starwheel 24 of an adjacent, preceding, processing station 20. The can body 1 moves with pocket 34 as the vacuum starwheel 32 rotates in a direction as shown by the arrow 52, until the can body 1 reaches a transfer point, such as generally indicated at 54, wherein the can body 1 transfers from the vacuum starwheel 32 to the non-vacuum starwheel 24 of the process turret 22. The can body 1 then moves with the non-vacuum starwheel 24 as it rotates in a direction as shown by the arrow 56 about a rotation axis 57, until the can body 1 reaches another transfer point, such as generally shown at 58, wherein the (now partially necked) can body 1 is transferred to the vacuum starwheel 32 of an adjacent downstream processing station 20. Accordingly, it is to be appreciated that transfer points 50 and 58 correspond among each processing station 20 of the necker machine 10.

As alluded to above, as the can body 1 moves from transfer point 54 to transfer point 58, the can body 1 is partially necked a predetermined amount by selectively moving the can body 1, and more particularly the open first end 6 (FIG. 4) of the can body 1 into engagement with a respective forming die assembly or forming die 60 (either referred to herein simply as “forming die 60”) of a plurality of forming dies 60 of the process turret 22 and then subsequently disengaging the can body 1 from the respective forming die 60 prior to transfer from the starwheel 24. Such portion of the travel of a can body 1 about process turret 22 is commonly referred to as the necking process window. Although the passage of a single can body 1 has been described, it is to be appreciated that in operation a stream of can bodies 1 positioned in the adjacent pockets of the starwheels 32 and 24 would pass through the processing station 20′. Accordingly, at any given time several can bodies 1 are passing between transfer points 54 and 58 and thus each being necked by a respective forming die 60 with which each can body 1 is engaged and subsequently disengaged during such time.

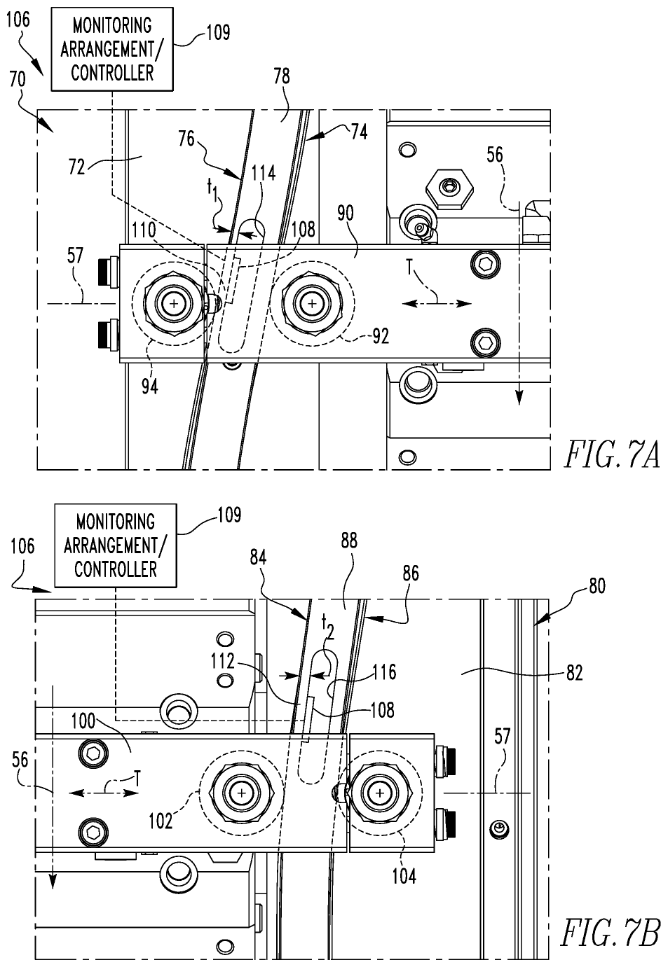

Continuing to refer to FIGS. 5 and 6, as well as FIGS. 7A and 7B, engagement and disengagement of the can bodies 1 with the forming dies 60 while moving through the process window is generally controlled by a forming cam arrangement 70 and a knockout cam arrangement 80 provided as parts of processing station 20′. More particularly, the forming cam arrangement 70 controls engagement of a given can body 1 with an associated forming die 60 of the plurality of forming dies 60, while the knockout cam arrangement 80 controls disengagement of the given can body 1 with the associated forming die 60. Forming cam arrangement 70 is fixedly coupled, directly or indirectly, to the frame assembly 36, adjacent process turret 22 and the open side of the forming dies 60, such that when process turret 22 is rotating about axis 57 during operation of necker machine 10, forming cam arrangement 70 does not rotate. The forming cam arrangement 70 includes a forming cam body 72 having a cam surface 74 defining a cam profile. In the example embodiment shown in FIGS. 5, 6 and 7A, the forming cam body 72 is generally disc-shaped and centered on rotation axis 57 while cam surface 74 is one of an opposing pair of cam surfaces 74 and 76 defined on a thinned portion 78 of the forming cam body 72 at the radial extent of the forming cam body 72. The knockout cam arrangement 80 is also fixedly coupled, directly or indirectly, to the frame assembly 36, adjacent the process turret 22 but on the opposite side of the forming dies 60 from the forming cam arrangement 70, such that when the process turret 22 is rotating about axis 57 during operation of necker machine 10, knockout cam arrangement 80 does not rotate. The knockout cam arrangement 80 includes a knockout cam body 82 having a cam surface 84 defining a cam profile. In the example embodiment shown in FIGS. 5, 6 and 7A, the knockout cam body 82 is generally disc-shaped and centered on rotation axis 57 while cam surface 84 is one of an opposing pair of cam surfaces 84 and 86 defined on a thinned portion 88 of the knockout cam body 82 at the radial extent of the knockout cam body 82.

The forming cam arrangement 70, and more particularly the cam surfaces 74 and 76 thereof, drive a plurality of forming cam followers 90 (only one is shown in each of FIGS. 5, 6 and 7A) that are circumferentially spaced about the process turret 22. Each forming cam follower 90 has a corresponding forming die 60 associated therewith (i.e., the quantity of forming cam followers 90 provided on the process turret 22 is the same as the quantity of forming dies 60 provided on process turret 22). Each forming cam follower 90 is slidably coupled to/carried on the process turret 22 in a manner such that each forming cam follower 90 can translate back and forth parallel to axis 57 (as shown by arrow T, FIG. 7A) as process turret 22 rotates about axis 57. Such translation of each of the forming cam followers 90 is driven by rollers 92 and 94 (shown in hidden line in FIG. 7A) included as portions of the forming cam follower 90 that engage, respectively, with cam surfaces 74 and 76 of the forming cam body 72. In operation, translation of each forming cam follower 90 away from the forming cam arrangement 70 as the process turret 22 rotates about the axis 57 (as shown by the arrow 56), i.e., by cam surface 74 exerting a force onto roller 92, causes one or more components operatively and or otherwise coupled to the forming cam follower 90 to force a can body 1 into engagement with the forming die 60 associated with the particular forming cam follower 90, thus necking the portion of the can body 1 interacting with the forming die 60 a predetermined amount. Conversely, translation of the forming cam follower 90 toward the forming cam arrangement 70 as the process turret 22 rotates about the axis 57 (as shown by the arrow 56), i.e., by cam surface 76 exerting a force onto roller 94, causes the one or more components operatively and or otherwise coupled thereto to back away from the forming die 60 associated with the particular forming cam follower 90, and thus allows for the can body 1 to disengage from the forming die 60 associated with the particular forming cam follower 90.

Similar to the forming cam arrangement 70, the knockout cam arrangement 80 and more particularly the cam surfaces 84 and 86 thereof, drive a plurality of knockout cam followers 100 (only one is shown in each of FIGS. 5, 6 and 7B) circumferentially spaced about the process turret 22 generally at an opposite end of the process turret 22. Each knockout cam follower 100 has a corresponding forming die 60 (and forming cam follower 90) associated therewith (i.e., the quantity of knockout cam followers 100 provided on process turret 22 is the same as the quantity of forming dies 60 and forming cam followers 90 provided on process turret 22). Each knockout cam follower 100 is slidably coupled to/carried on the process turret 22 in a manner such that each knockout cam follower 100 can translate back and forth parallel to axis 57 (as shown by arrow T) as process turret 22 rotates about axis 57. Such translation of each of the knockout cam followers 100 is driven by rollers 102 and 104 (shown in hidden line in FIG. 7B) included as portions of the knockout cam follower 100 that engage, respectively, with cam surfaces 84 and 86 of the knockout cam body 82. In operation, translation of the knockout cam follower 100 away from the knockout cam arrangement 80 as the process turret 22 rotates about the axis 57 (as shown by the arrow 56), i.e., by cam surface 84 exerting a force onto roller 102, causes one or more components operatively and or otherwise coupled to the knockout cam follower 100 to force a can body 1 from engagement with the forming die 60 associated with the particular knockout cam follower 100 and back out from the forming die to the starwheel 24. Conversely, translation of the knockout cam follower 100 toward the knockout cam arrangement 80 as the process turret 22 rotates about the axis 57 (as shown by the arrow 56), i.e., by cam surface 86 exerting a force onto roller 104, causes the one or more components operatively and or otherwise coupled thereto to back away from the forming die 60 associated with the particular cam follower 100, and thus allows for next can body 1 to move into engagement with the forming die 60 as the associated forming cam follower 90 moves the next can body 1 accordingly.

Referring now to the detail views of FIGS. 7A and 7B, one or both of the forming cam arrangement 70 and/or the knockout cam arrangement 80 further include a sensing arrangement 106 that is structured to determine the force(s) applied to a portion of a cam surface, e.g., 74, 76, 84, 86, of the cam arrangement 70, 80 during necking operations. The sensing arrangement 106 includes a sensor 108 and a monitoring arrangement/controller 109 in communication with the controller for determining the force(s) applied to the cam surface of the forming cam body 72 and/or the knockout cam body 82. Depending on the particular sensor(s) 108 and quantity thereof employed, a single monitoring arrangement/controller 109 in communication with multiple sensors 108 may be employed. In the example embodiment shown in FIGS. 7A and 7B, a strain gauge is employed as the sensor 108. In such example embodiment, selected portions 110, 112 of the forming and knockout cam bodies 72 and 82 bounded by a portion of the cam surfaces 76 and 84 are structured to selectively elastically deform in a predetermined manner responsive to forces applied thereto via the cam follower 90, 100, and more particularly applied thereto via the respective roller 94, 102 thereof. To provide for such selective deformation of portions 110 and 112, each cam body 72, 82 further includes a pocket 114, 116 defined therein within thinned portion 78, 88 which houses at least a portion of the strain gauge 106. The amount of deformation of either of portions 110 or 112, and thus the strain induced therein by the associated roller 94, 102 of the cam follower 90, 100 depends both on the force required to drive the associated components at such time (i.e., the force withdrawing the forming cam follower 90 away from a forming die 60, or the force required to push a can body 1 away from the forming die 60) and also the thickness t₁, t₂ of portions 110, 112. If the supporting material adjacent to the cam surface 76/84 is thinned to a certain degree, then the force from the cam follower 90/100 will induce a certain known amount of deformation/strain into the supporting material (i.e., portion 110, 112). By choosing the thickness t₁, t₂ of the supporting material, the expected strain induced by the cam follower 90, 100 can be placed within the measurement range of commonly available strain gauges, thereby, giving a relative measurement of the force required to force the can body 1 into the forming die 60 or away from the forming die 60. While in such example sensor 108 is a strain gauge and monitoring arrangement/controller 109 is a data acquisition/analysis system, it is to be appreciated that other suitable sensor(s) and/or monitoring arrangements/controllers may be employed without varying from the scope of the disclosed concept. For example, without limitation, a pressure sensor positioned within a tight fitting pocket may be employed.

By monitoring the forces applied at one or more locations along the cam surfaces of one or both of the forming cam body 72 and/or the knockout cam body 82 during necking operations, health estimates of components driven by the cam arrangement(s) 70, 80 can be determined, as well as rapid detections of jams or other sudden problems. By continually monitoring the force(s) applied to selected portions of one or more of cam surfaces 74, 76, 84, 86 by the associated roller 92, 94, 102, 104 of the cam followers 90, 100 during operation of the necker machine 10, a baseline can be developed for how much force is required to actuate the associated components during necking operations. Once this baseline is acquired, subsequent force data can be compared to the baseline to give an indication of the health of the mechanism or to assist with diagnostics. For example, an increase in force may indicate a jam in the machine, whereas a decrease in force may indicate an absence of a can body or that some kind of mechanical failure has occurred. In either circumstance, the program carried out by the monitoring arrangement/controller 109 can stop the machine in a shorter period of time to avoid a major breakdown or slip in timing of the machine. As another example, if the relative force measurement has increased gradually over a substantial amount of time, then perhaps bearings within the mechanism are due for maintenance and should be re-greased. It is to be appreciated that the quantity and/or positioning of the sensing arrangements 106/sensors 108 may be varied depending on the cam profile(s) employed and the desired level of monitoring without varying from the disclosed concept. Further, it is also to be appreciated that such sensing arrangement(s) 106 may be employed on only one of the forming cam arrangement 70 or the knockout cam arrangement 80 without varying from the scope of the disclosed concept.

From the foregoing it is to be appreciated that embodiments of the disclosed concept provide diagnostic and monitoring information pertinent to the primary functional mechanism of necker machines used in manufacturing can bodies. In such machines, embodiments of the disclosed concept can be employed to provide health estimates of components driven by the cam arrangement(s) by monitoring the force required to drive the mechanism during normal operation. By providing improved monitoring/estimations of health, maintenance can be better optimized and failures and downtime can be reduced.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. A processing station for use in a die necking machine, the processing station comprising:
a frame;
a forming cam arrangement fixedly coupled to the frame;
a knockout cam arrangement fixedly coupled to the frame; and
a process turret rotatably coupled to the frame, the process turret comprising:
a forming cam follower operatively coupled to the forming cam arrangement; and
a knockout cam follower operatively coupled to the knockout cam arrangement,
wherein one or both of the forming cam arrangement and/or the knockout cam arrangement comprises:
a cam body having a cam surface defining a cam profile, the cam surface configured to be engaged by a cam follower of one of the forming cam follower or the knockout cam follower; and
a sensing arrangement structured to determine a force applied to a portion of the cam surface by the cam follower of the one of the forming cam follower or the knockout cam follower.

2. The processing station of claim 1, wherein:
the portion of the cam surface bounds a portion of the cam body that is sized and configured to deform in a predetermined manner responsive to one or more forces applied to the portion of the cam surface via the one of the cam follower; and
the sensing arrangement is structured to monitor deformation of the portion of the cam body.

3. The processing station of claim 2, wherein the cam body comprises a pocket defined therein, and wherein the portion of the cam body is disposed between the pocket and the portion of the cam surface.

4. The processing station of claim 3, wherein the sensing arrangement comprises a sensor disposed at least partially within the pocket.

5. The processing station of claim 4, wherein the sensor comprises a strain gauge coupled to the portion of the cam body or a pressure sensor engaged with the portion of the cam body.

6. The processing station of claim 4, wherein the sensing arrangement comprises a controller in communication with the sensor.

7. The processing station of claim 6, wherein the controller is structured to determine the force exerted by the cam follower from the deformation.

8. The processing station of claim 1, wherein each of the forming cam arrangement and the knockout cam arrangement comprises:
the cam body having the cam surface defining the cam profile; and
the sensing arrangement structured to determine the force applied to the portion of the cam surface.

9. The processing station of claim 1, wherein the sensing arrangement is structured to determine forces applied to a plurality of portions of the cam surface by the cam follower of the one of the forming cam follower or the knockout cam follower.

10. A die necking machine for use in forming can bodies, the die necking machine comprising a plurality of processing stations, each processing station comprising:
a frame;
a forming cam arrangement fixedly coupled to the frame;
a knockout cam arrangement fixedly coupled to the frame; and
a process turret rotatably coupled to the frame, the process turret comprising:
a forming cam follower operatively coupled to the forming cam arrangement; and
a knockout cam follower operatively coupled to the knockout cam arrangement,
wherein one or both of the forming cam arrangement and/or the knockout cam arrangement comprises:
a cam body having a cam surface defining a cam profile, the cam surface configured to be engaged by a cam follower of one of the forming cam follower or the knockout cam follower; and
a sensing arrangement structured to determine a force applied to a portion of the cam surface by the cam follower of the one of the forming cam follower or the knockout cam follower.

11. The die necking machine of claim 10, wherein:
the portion of the cam surface bounds a portion of the cam body that is sized and configured to deform in a predetermined manner responsive to one or more forces applied to the portion of the cam surface via the one of the cam follower; and
the sensing arrangement is structured to monitor deformation of the portion of the cam body.

12. The die necking machine of claim 11, wherein the cam body comprises a pocket defined therein, and wherein the portion of the cam body is disposed between the pocket and the portion of the cam surface.

13. The die necking machine of claim 12, wherein the sensing arrangement comprises a sensor disposed at least partially within the pocket.

14. The die necking machine of claim 13, wherein the sensor comprises a strain gauge coupled to the portion of the cam body or a pressure sensor engaged with the portion of the cam body.

15. The die necking machine of claim 13, wherein the sensing arrangement comprises a controller in communication with the sensor.

16. The die necking machine of claim 15, wherein the controller is structured to determine the force exerted by the cam follower from the deformation.

17. The die necking machine of claim 10, wherein each of the forming cam arrangement and the knockout cam arrangement comprises:
the cam body having the cam surface defining the cam profile; and
the sensing arrangement structured to determine the force applied to the portion of the cam surface.

18. The die necking machine of claim 10, wherein the sensing arrangement is structured to determine forces applied to a plurality of portions of the cam surface by the cam follower of the one of the forming cam follower or the knockout cam follower.

19. A method for determining a condition requiring service in a processing station of a die necking machine, the processing station having a frame; a forming cam arrangement fixedly coupled to the frame; a knockout cam arrangement fixedly coupled to the frame; and a process turret rotatably coupled to the frame, the process turret having: a forming cam follower operatively coupled to the forming cam arrangement; and a knockout cam follower operatively coupled to the knockout cam arrangement, wherein one or both of the forming cam arrangement and/or the knockout cam arrangement includes: a cam body having a cam surface defining a cam profile, the cam surface configured to be engaged by a cam follower of one of the forming cam follower or the knockout cam follower; the method comprising:
monitoring force applied to at least a portion of the cam surface by the cam follower of the one of the forming cam follower or the knockout cam follower during operation of the die necking machine;
determining that the force applied to the portion of the cam surface has varied more than a predetermined amount from a predetermined value; and
performing an action responsive to determining that the force has varied more than the predetermined amount.

20. The method of claim 19, wherein performing the action comprises stopping operation of the die necking machine.
